(19) United States
(12) Patent Application Publication
(10) Pub. No.: US 2008/0042730 A1
(43) Pub. Date: Feb. 21, 2008

(54) Internal voltage generating circuit and method for generating internal voltage using the same

(75) Inventor: Khil-Ohk Kang, Kyoungki-do (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Hynix Semiconductor Inc.

(21) Appl. No.: 11/823,313

(22) Filed: Jun. 27, 2007

(30) Foreign Application Priority Data
Jun. 29, 2006 (KR) 2006-0059604
Jun. 29, 2006 (KR) 2006-0059860

(51) Int. Cl. G05F 1/10; G05F 3/02

(52) U.S. Cl. 327/536; 327/537; 327/538

(57) ABSTRACT

An internal voltage generating circuit includes: a voltage supplying unit configured to selectively supply an external power supply voltage or a pumping voltage having a voltage level higher than the external power supply voltage, and an internal voltage generating unit configured to use the voltage supplied from the voltage supplying unit as a supply voltage.

### CROSS-REFERENCES TO RELATED APPLICATIONS

The present invention claims priority of Korean patent application numbers 10-2006-0059860 and 10-2006-0059604, filed on Jun. 29, 2006, which are incorporated by reference in their entirety.

### BACKGROUND OF THE INVENTION

The present invention relates to a semiconductor device, and more particularly, to an internal voltage generating circuit for generating an internal voltage that maintains a stable level at a relatively low voltage.

As semiconductor memory devices become high-speed, high-density and have low power consumption, an internal voltage is used in a dynamic random access memory (DRAM). The internal voltage is generated by charge-pumping or down-converting a reference voltage.

An internal voltage generated using charge pumping includes a high voltage (VPP) and a back bias voltage (VBB), and an internal voltage generated using down conversion includes a core voltage (VCORE).

The generation of the high voltage (VPP) aims to apply a voltage higher than an external power supply voltage (VDD) to a gate of a cell transistor (or a word line) so as to access a memory cell without loss of cell data.

The generation of the back bias voltage (VBB) aims to apply a voltage lower than an external ground voltage (VSS) to a bulk of a cell transistor so as to prevent loss of data.

The generation of the core voltage (VCORE) aims to reduce power loss and obtain a stable core operation. The core voltage (VCORE) is generated by down-converting an external power supply voltage (VDD). The core voltage (VCORE) is lower than an external power supply voltage (VDD) and maintains a constant voltage level within an active region, regardless of a change in the voltage level of the external power supply voltage. The core voltage (VCORE) may be generated using an operational amplifier (OP-AMP)

FIG. 1 is a block diagram illustrating a conventional internal voltage generating circuit of a dynamic random access memory (DRAM).

As shown, a reference voltage generating unit 10 receives an external power supply voltage VDDEXT to generate a reference voltage VREF.

An internal voltage generating unit 20 generates an internal voltage IN_VOL in response to the reference voltage VREF. The internal voltage IN_VOL includes a high voltage VPP, a back bias voltage VBB, and a core voltage VCORE.

An internal circuit 30 performs a preset operation using the internal voltage IN_VOL.

FIG. 2 is a circuit diagram of the internal voltage generating unit 20 illustrated in FIG. 1.

As shown, the internal voltage generating unit 20 includes a comparator configured to receive the reference voltage VREF to generate the internal voltage IN_VOL when an enable signal IN is activated to logic HIGH.

More specifically, when the enable signal IN is activated to logic HIGH, PMOS transistors P2, P5 and P7 are turned off, while an NMOS transistor N3 is turned on. Hence, the internal voltage generating unit 20 begins to operate.

The internal voltage generating unit 20 operates in two states in accordance with a level of a half voltage HALF.

The half voltage HALF is a voltage produced when the internal voltage IN_VOL from the internal voltage generating unit 20 is divided in accordance with the resistances of resistors R0 and R1. If the resistances of the resistors R0 and R1 are equal to each other, the half voltage HALF corresponds to half the internal voltage IN_VOL.

First, a case where the internal voltage generating unit 20 is in an initial state and thus the half voltage HALF is lower than the reference voltage VREF will be described below. It is assumed that the half voltage HALF is higher than a threshold voltage (Vt) of an NMOS transistor N2, and NMOS transistors N1 and N2 serving as two input terminals of the comparator have the same size.

Since the half voltage HALF is lower than the reference voltage VREF, a gate-source voltage (VGS) of the NMOS transistor N1 is higher than a gate-source voltage (VGS) of the NMOS transistor N2. Hence, the drop in voltage at a node A is greater than at node C. The voltage drop at the node A turns on a PMOS transistor P1, and an external power supply voltage VDD applied to the PMOS transistor P1 passes through a node B and turns on an NMOS transistor N5. Likewise, the voltage drop at the node C turns on a PMOS transistor P6. However, compared with the NMOS transistor N5 turned on by the voltage drop at the node A, the PMOS transistor P6 is turned on slightly. Thus, a charge supply capability of the PMOS transistor P6 is less than that of the NMOS transistor N5.

Consequently, a driving node IN becomes logic LOW and a PMOS transistor P8 is turned on in response to the logic LOW level of the driving node IN, so that the level of the internal voltage IN_VOL increases. The level of the internal voltage IN_VOL continues to increase until the half voltage HALF becomes higher than the reference voltage VREF.

Second, a case where the half voltage HALF is higher than the reference voltage VREF will be described below.

Since the half voltage HALF is higher than the reference voltage VREF, a gate-source voltage (VGS) of the NMOS transistor N1 is lower than a gate-source voltage (VGS) of the NMOS transistor N2. Hence, a voltage drop at the node A is smaller than a voltage drop at the node C. The voltage drop at the node C turns on the PMOS transistor P6. Likewise, the voltage drop at the node A turns on the PMOS transistor P1, and an external power supply voltage VDD applied to the PMOS transistor P1 passes through the node B and turns on the NMOS transistor N5. However, compared with the NMOS transistor N6 turned on by the voltage drop at the node C, the PMOS transistor P5 is turned on slightly. Hence, a charge supply capability of the PMOS transistor P5 is less than that of the NMOS transistor N6.

Consequently, the driving node IN becomes logic HIGH and the PMOS transistor P8 is turned off in response to the logic HIGH level of the driving node IN, so that the external power supply voltage VDD is not supplied to an output terminal OUT of the internal voltage generating unit 20. This operation is continued until the half voltage HALF becomes lower than the reference voltage VREF.

FIG. 3 is a simulation graph showing a level variation of the internal voltages when the internal voltage generated using a normal voltage and the internal voltage generated using a low voltage are respectively used in the internal circuit.

Two cases are illustrated in FIG. 3. A first case is that the internal voltage generating unit 20 receives a normal voltage of 1.8 V to generate a first internal voltage, and a second case is that the internal voltage generating unit 20 receives a low VDD voltage of 1.6 V to generate a second internal voltage. It can be seen from FIG. 3 that problems occur in the second case rather than the first case.

When the first internal voltage generated using the normal voltage of 1.8 V and the second internal voltage generated using the low VDD voltage of 1.6 V are used in the same internal circuit 30, a voltage drop of the second internal voltage is greater than a voltage drop of the first internal voltage. This is because an amount of charge supplied to the driver (the PMOS transistor P8 in FIG. 2) for driving the internal voltage in the internal voltage generating unit 20 is larger in the first case than in the second case.

After the first internal voltage and the second internal voltage are used in the same internal circuit 30, the second internal voltage recovers to the original voltage level more slowly than the first internal voltage. This is because a charge supply capability of the driver (the PMOS transistor P8 in FIG. 2) for driving the internal voltage IN_VOL in the internal voltage generating unit 20 is deficient.

These limitations lead to the failure of the internal circuit 30 that uses the internal voltage IN_VOL.

### SUMMARY OF THE INVENTION

Embodiments of the present invention are directed at providing an internal voltage generating circuit for generating an internal voltage that maintains a stable level at a relatively low voltage.

In accordance with an aspect of the present invention, there is provided an internal voltage generating circuit, including: a voltage supplying unit configured to selectively supply an external power supply voltage or a pumping voltage having a voltage level higher than the external power supply voltage; and an internal voltage generating unit configured to use the voltage supplied from the voltage supplying unit as a supply voltage.

In accordance with another aspect of the present invention, there is provided an internal voltage generating circuit, including: a reference voltage generating unit configured to receive an external power supply voltage to generate a reference voltage; a pumping voltage generating unit configured to generate a pumping voltage having a voltage level higher than the external power supply voltage; a voltage supplying unit configured to receive an activation signal corresponding to a preset operation of a dynamic random access memory (DRAM) to supply the pumping voltage or the external power supply voltage in response to the activation signal; an internal voltage generating unit configured to generate an internal voltage in response to the reference voltage, the internal voltage generating unit being configured to use the voltage supplied from the voltage supplying unit as a supply voltage; and an internal circuit configured to receive the internal voltage to perform a preset operation.

In accordance with still another aspect of the present invention, there is provided a method for generating an internal voltage, including: generating an activation signal in response to a preset operation of a dynamic random access memory (DRAM); generating a pulse toggled in response to the activation signal; supplying a pumping voltage or an external power supply voltage in response to the toggling of the pulse; and receiving the pumping voltage or the external power supply voltage to generate the internal voltage.

In accordance with further another aspect of the present invention, there is provided an internal voltage generating circuit, including: a reference voltage generating unit configured to receive an external power supply voltage to generate a first reference voltage and a second reference voltage; a pumping voltage generating unit configured to generate a pumping voltage having a voltage level higher than the external power supply voltage; a voltage supplying unit configured to detect a level of the external power supply voltage in response to the first reference voltage and supply the pumping voltage or the external power supply voltage in accordance with the detection result; an internal voltage generating unit configured to generate the internal voltage in response to the second reference voltage and use the voltage supplied from the voltage supplying unit as a supply voltage; and an internal circuit configured to receive the internal voltage to perform a preset operation.

### BRIEF DESCRIPTION OF THE DRAWINGS

FIG. 1 is a block diagram illustrating a conventional internal voltage generating circuit of a dynamic random access memory (DRAM);

FIG. 2 is a circuit diagram of an internal voltage generating unit illustrated in FIG. 1;

FIG. 3 is a simulation graph showing a level variation of the internal voltages for the internal voltage being generated using a normal voltage, and for the internal voltage being generated using a low voltage;

FIG. 4 is a block diagram of an internal voltage generating circuit of a DRAM in accordance with a first embodiment of the present invention;

FIG. 5 is a circuit diagram of an internal voltage generator and a voltage supplying unit illustrated in FIG. 4;

FIG. 6 is a simulation graph showing a level variation of the internal voltages when the internal voltages, generated using the low VDD voltage of 1.6 V in the internal voltage generating circuits of FIGS. 1 and 4, are used in the internal circuit;

FIG. 7 is a block diagram of an internal voltage generating circuit of a DRAM in accordance with a second embodiment of the present invention;

FIG. 8 is a circuit diagram of an internal voltage generator and a voltage supplying unit as illustrated in FIG. 7; and

FIG. 9 is a simulation graph showing a level variation of the internal voltages when the internal voltages, generated using the low VDD voltage of 1.6 V in the internal voltage generating circuits of FIGS. 1 and 7, are respectively used in the internal circuit.

### DESCRIPTION OF SPECIFIC EMBODIMENTS

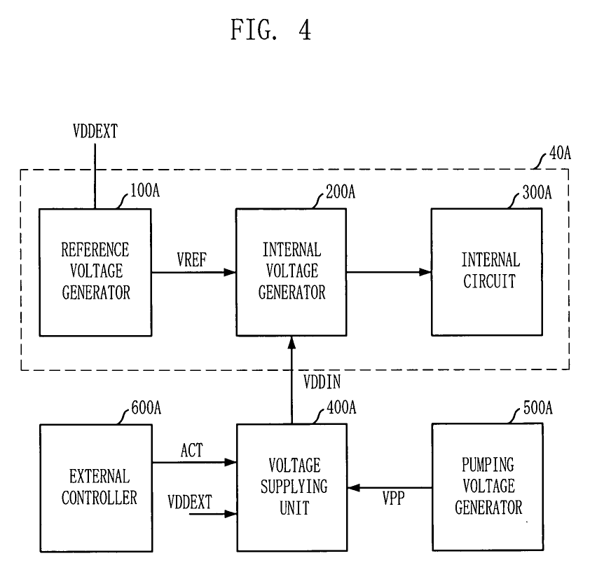

FIG. 4 is a block diagram of an internal voltage generating circuit of a DRAM in accordance with a first embodiment of the present invention.

As shown, the internal voltage generating circuit includes a voltage supplying unit 400A for supplying a pumping voltage VPP or an external power supply voltage VDDEXT, wherein the selection between the two is in response to an activation signal ACT, and an internal voltage generating unit 40A configured to use a supply voltage VDDIN output from the voltage supplier 400A as a supply voltage.

More specifically, the internal voltage generating unit 40A includes a reference voltage generator 100A for receiving the external power supply voltage VDDEXT to generate a reference voltage VREF, an internal voltage generator 200A for generating an internal voltage IN_VOL in response to the reference voltage VREF, and an internal circuit 300A for receiving the internal voltage IN_VOL to operate a preset operation.

In addition, the internal voltage generating circuit further includes an external controller 600A for outputting the activation signal ACT which is activated in response to the operation of the DRAM, and a pumping voltage generator 500A for generating the pumping voltage VPP higher than the external power supply voltage VDDEXT.

A voltage supplying process of the DRAM in accordance with the first embodiment of the present invention will be described below.

First, the reference voltage generator 100A receives the external power supply voltage VDDEXT to generate the reference voltage VREF.

Second, the pumping voltage generator 500A generates the pumping voltage VPP higher than the external power supply voltage VDDEXT. The pumping voltage VPP is used to read/write data from/to a cell transistor and is higher than the external power supply voltage VDDEXT supplied for the operation of the DRAM.

Third, the voltage supplying unit 400A supplies the pumping voltage VPP or the external power supply voltage VDDEXT, as the supply voltage VDDIN of the internal voltage generator 200A, in response to the activation signal ACT inputted from the external controller 600A.

When the level of the external power supply voltage VDDEXT is relatively low, the pumping voltage VPP generated from the pumping voltage generator 500A is supplied as the supply voltage VDDIN of the internal voltage generator 200A. On the other hand, when the level of the external power supply voltage VDDEXT is normal, the external power supply voltage VDDEXT is supplied as the supply voltage VDDIN of the internal voltage generator 200A.

The external controller 600A activates the activation signal ACT in an active operation or refresh operation of the DRAM in which the level of the external power supply voltage VDDEXT becomes relatively low. On the other hand, the external controller 600A deactivates the activation signal ACT in a precharge operation of the DRAM.

Fourth, the internal voltage generator 200A generates the internal voltage IN_VOL in response to the reference voltage VREF. The internal voltage IN_VOL may be a back bias voltage (VBB) or a core voltage (VCORE).

Fifth, the internal circuit 300A receives the internal voltage IN_VOL and performs its preset operation. The internal circuit 300 refers to all circuits of the memory device, which use the internal voltage IN_VOL.

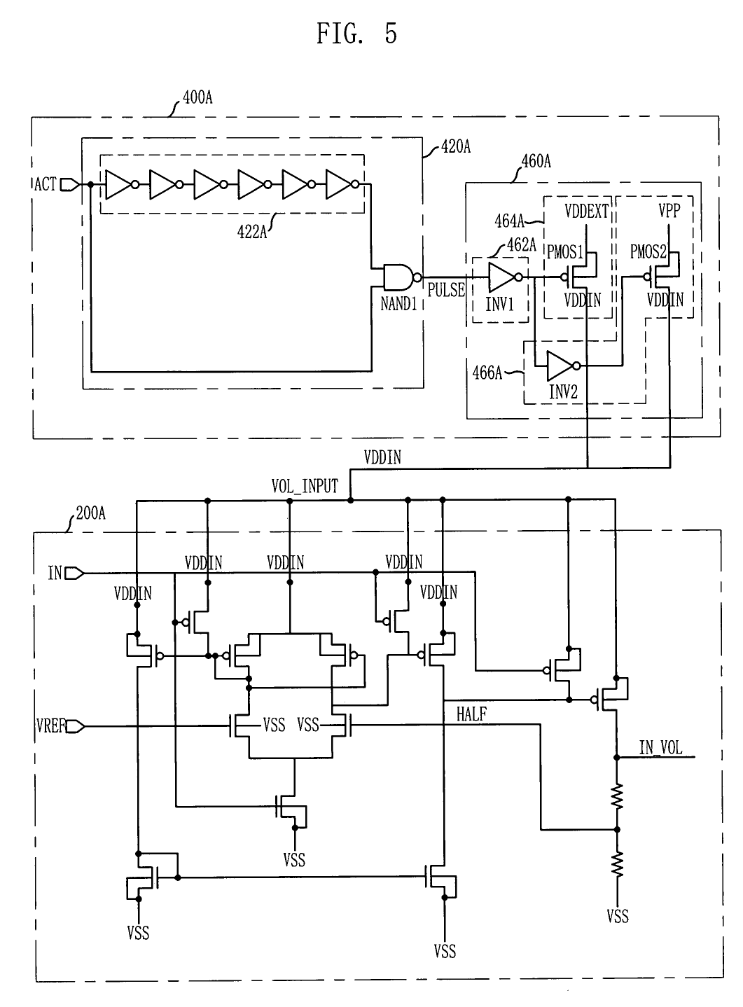

FIG. 5 is a circuit diagram of the internal voltage generator 200A and the voltage supplying unit 400A illustrated in FIG. 4.

The voltage supplying unit 400A receives the activation signal ACT from the external controller 600A and supplies the pumping voltage VPP or the external power supply voltage VDDEXT in response to the activation signal ACT.

The external controller 600A activates the activation signal ACT in the active operation or refresh operation of the DRAM in which the level of the external power supply voltage VDDEXT becomes relatively low.

In addition, the voltage supplying unit 400A supplies the pumping voltage VPP as the supply voltage of the internal voltage generator 200A when the activation signal ACT is activated. On the other hand, the voltage supplying unit 400A supplies the external power supply voltage VDDEXT as the supply voltage of the internal voltage generator 200A when the activation signal ACT is deactivated.

The voltage supplying unit 400A includes a pulse generator 420A and a driver 460A. The pulse generator 420A generates a pulse toggled for a predetermined time in response to the activation signal ACT. The driver 460A drives the pumping voltage VPP or the external power supply voltage VDDEXT in response to the toggling of the pulse.

The pulse generator 420A includes a first delay circuit 422A and a first NAND gate NAND1. The first delay circuit 422A delays the activation signal ACT by a predetermined time, and the first NAND gate NAND1 receives an output signal of the first delay circuit 422A and the activation signal ACT.

The first delay circuit 422A includes an inverter chain with a plurality of inverters. In the first delay circuit 422A, a phase of an input signal is equal to that of an output signal.

The driver 460A includes a first driver 462A, a second driver 464A, and a third driver 466A. The first driver 462A drives the pulse PULSE to logic HIGH or logic LOW in response to the toggling of the pulse PULSE. The second driver 464A drives the external power supply voltage VDDEXT in response to an output signal of the first driver 462A. The third driver 466A drives the pumping voltage VPP in response to an inverted output signal of the first driver 462A.

The first driver 462A includes a first inverter INVL configured to invert the pulse PULSE.

The second driver 464A includes a first PMOS transistor PMOS1 having a drain connected to the external power supply voltage VDDEXT, a source connected to a voltage input node VOL_INPUT, and a gate receiving the output signal of the first driver 462A.

The third driver 466A includes a second inverter INV2 and a second PMOS transistor PMOS2. The second inverter INV2 inverts the output signal of the first driver 462A, and the second PMOS transistor PMOS2 has a source connected to the pumping voltage VPP, a drain connected to the voltage input node VOL_INPUT, and a gate receiving an output signal of the second inverter INV2.

The pumping voltage VPP or the external power supply voltage VDDEXT supplied from the voltage supplying unit 400A are used as the supply voltage of the internal voltage generator 200A.

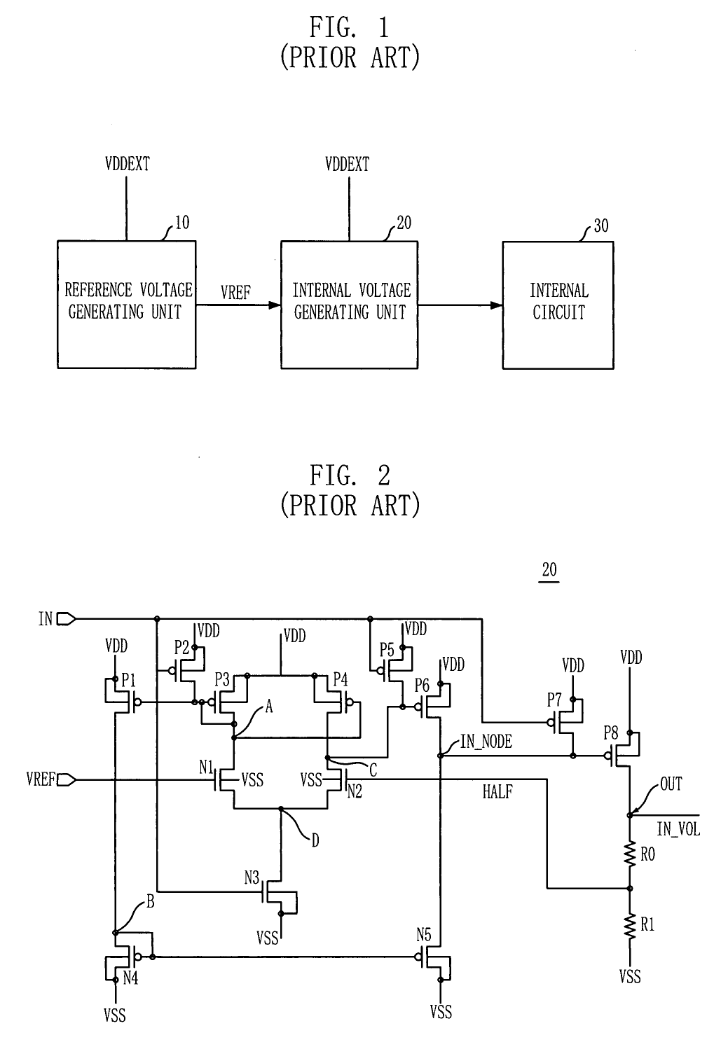

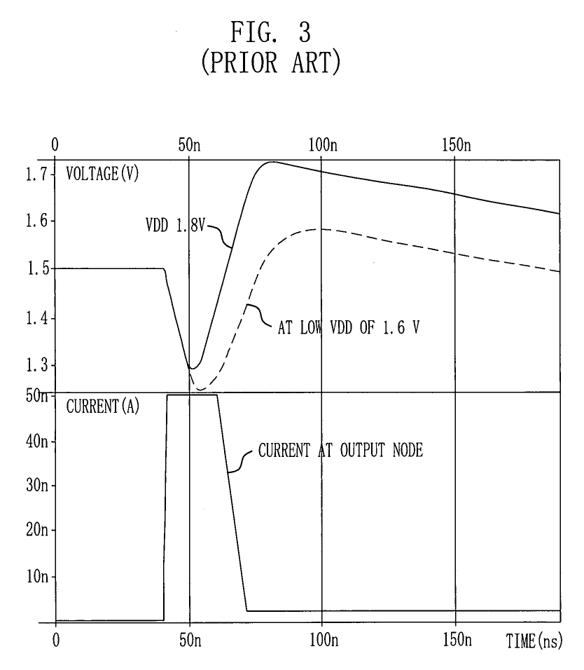

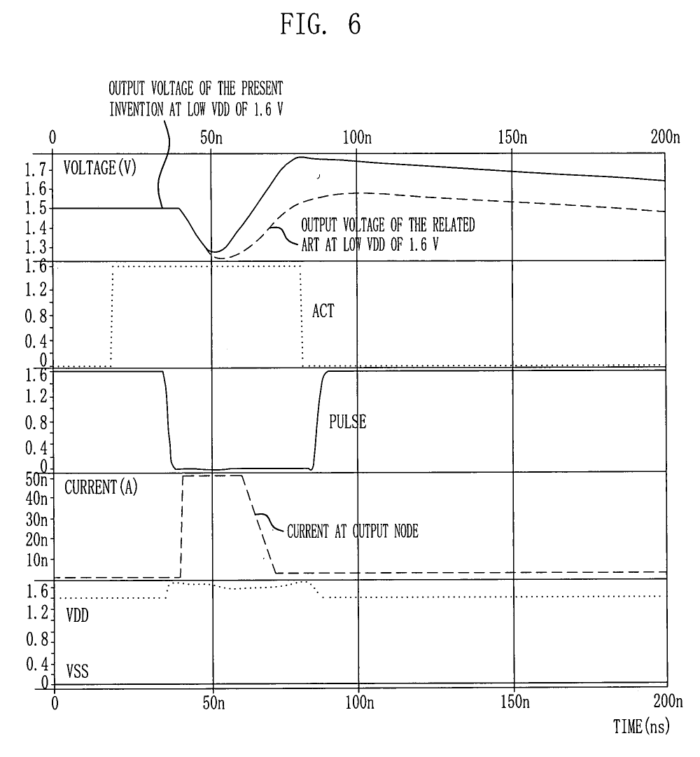

FIG. 6 is a simulation graph showing a level variation of the internal voltages when the internal voltages generated using the low VDD voltage of 1.6 V in the internal voltage generating circuits of FIGS. 1 and 4, are used in the internal circuit.

As shown, a level of the internal voltage IN_VOL in the internal voltage generating circuit of FIG. 4 is changed differently from that in the internal voltage generating circuit of FIG. 1.

When the activation signal ACT indicating that the external power supply voltage VDDEXT is the low voltage is activated to logic HIGH in the circuit, the pulse is toggled after a predetermined time elapses.

In other words, even though the internal voltage IN_VOL generated in the pulse toggling section is used in the internal circuit 300A, the internal voltage IN_VOL maintains a relatively high level, compared with the case where the internal voltage IN_VOL generated from the conventional internal voltage generating circuit is used in the internal circuit 300A.

Likewise, when the internal voltages IN_VOL are used in the internal circuit 300A, the internal voltage IN_VOL generated by the internal voltage generating circuit 40A of FIG. 4 has a faster recovery speed than the internal voltage IN_VOL generated by the conventional internal voltage generating circuit of FIG. 1.

Therefore, the internal voltage generating circuit of the present invention operates more stably than the conventional internal voltage generating circuit of FIG. 1.

As described above, even when the level of the external power supply voltage becomes lower and thus a low voltage is inputted, the level of the internal voltage used in the internal circuit can be stably maintained using the pulse indicating the input timing. This makes the semiconductor device operate stably.

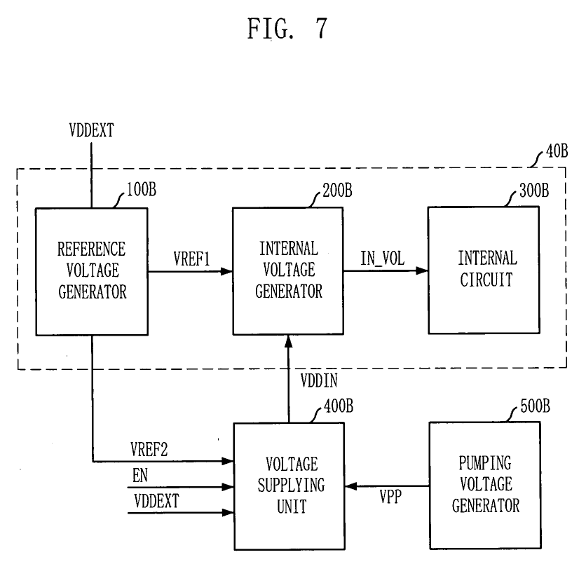

FIG. 7 is a block diagram of an internal voltage generating circuit of a DRAM in accordance with a second embodiment of the present invention.

As shown, the internal voltage generating circuit includes a voltage supplying unit 400B and an internal voltage generating unit 40B. The voltage supplying unit 400B detects a level of an external power supply voltage VDDEXT to supply a pumping voltage VPP or the external power supply voltage VDDEXT as the supply voltage VDDIN in accordance with the detection result, and the internal voltage generating unit 40B uses the voltage VDDIN supplied from the voltage supplying unit 400B as a supply voltage.

More specifically, the internal voltage generating unit 40B includes a reference voltage generator 100B for receiving the external power supply voltage VDDEXT to generate a first reference voltage VREF1 and a second reference voltage VREF2, an internal voltage generator 200B for generating an internal voltage IN_VOL in response to the first reference voltage VREF1 and uses the output voltage VDDIN of the voltage supplying unit 400B as a supply voltage, and an internal circuit 300B for receiving the internal voltage IN_VOL to perform its preset operation.

The voltage supplying unit 400B detects the level of the external power supply voltage VDDEXT in response to the second reference voltage VREF2 outputted from the reference voltage generator 100B and supplies the pumping voltage VPP or the external power supply voltage VDDEXT in accordance with the detection result.

In addition, the internal voltage generating circuit further includes a pumping voltage generator 500 for generating the pumping voltage VPP higher than the external power supply voltage VDDEXT.

A voltage supplying process of the DRAM in accordance with the second embodiment of the present invention will be described below.

First, the reference voltage generator 100B generates the first reference voltage VREF1 for the generation of the internal voltage and the second reference voltage VREF2 for the detection of the external power supply voltage VDDEXT. The level of the first reference voltage VREF1 may be equal to or different from that of the second reference voltage VREF2.

Second, the pumping voltage generator 500B generates the pumping voltage VPP. The pumping voltage VPP is a voltage that is used for reading/writing data from/to a cell transistor. The pumping voltage VPP is higher than the external power supply voltage VDDEXT supplied for the operation of the DRAM.

Third, the voltage supplying unit 400B detects the level of the external power supply voltage VDDEXT in response to the second reference voltage VREF2. When the level of the external power supply voltage VDDEXT is normal, the voltage supplying unit 400B supplies the external power supply voltage VDDEXT as a supply voltage of the internal voltage generator 200B. On the other hand, when the level of the external power supply voltage VDDEXT is low, the voltage supplying unit 400B supplies the pumping voltage VPP from the pumping voltage generator 500B as a supply voltage of the internal voltage generator 200B.

To determine whether the level of the external power supply voltage VDDEXT is normal or low can be modified by adjusting the second reference voltage VREF2, depending on types of the semiconductor device. In other words, the level of the external power supply voltage VDDEXT is previously determined by a designer and its result can be changed.

Fourth, the internal voltage generator 200B generates the internal voltage IN_VOL, such as a back bias voltage (VBB) and a core voltage (VCORE), in response to the first reference voltage VREF1.

Fifth, the internal circuit 300B receives the internal voltage IN_VOL and performs its operation. In other words, the internal circuit 300B refers to all circuits of the memory device, which use the internal voltage IN_VOL.

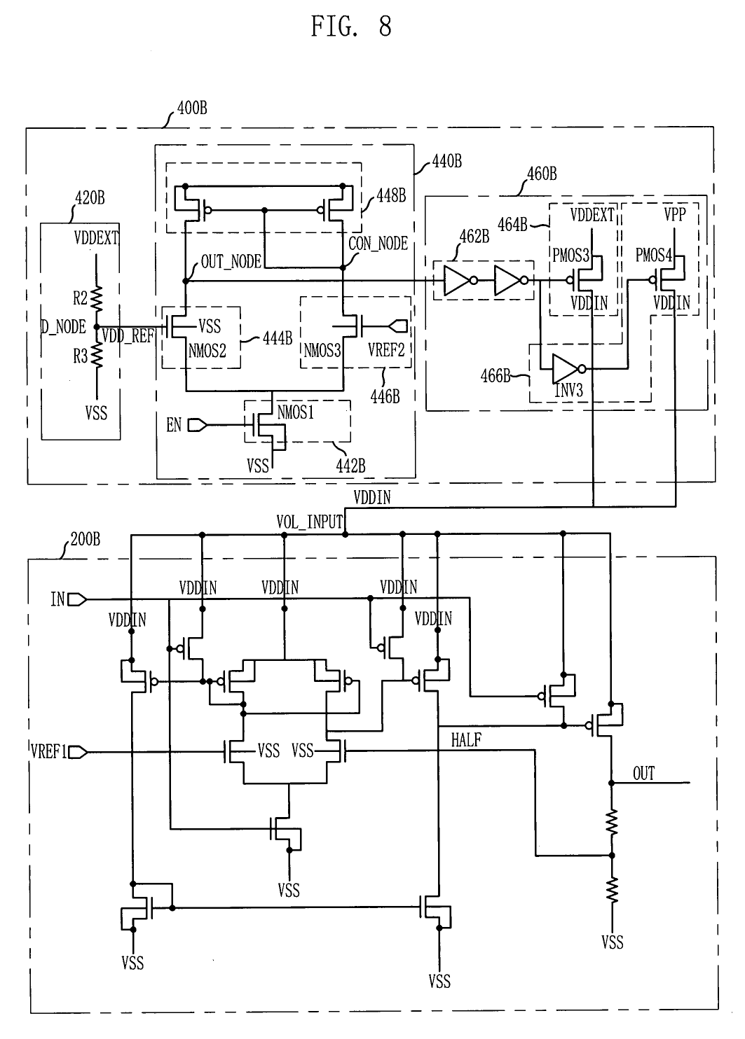

FIG. 8 is a circuit diagram of the internal voltage generator 200B and the voltage supplying unit 400B illustrated in FIG. 7.

As shown, the voltage supplying unit 400B detects the level of the external power supply voltage VDDEXT to supply the pumping voltage VPP or the external power supply voltage VDDEXT in accordance with the detection result. The internal voltage generator 200B uses the output voltage of the voltage supplying unit 400B, ether the pumping voltage VPP or the external power supply voltage VDDEXT, as a supply voltage.

The voltage supplying unit 400B supplies the pumping voltage VPP as a supply voltage of the internal voltage generator 200B when the level of the external power supply voltage VDDEXT is relatively low. On the other hand, the voltage supplying unit 400B supplies the external power supply voltage VDDEXT as a supply voltage of the internal voltage generator 200B when the level of the external power supply voltage VDDEXT is relatively high.

In addition, the voltage supplying unit 400B further includes a voltage divider 420B, a comparator 440B, and a driver 460B. The voltage divider 420B is connected in series between the external power supply voltage VDDEXT and the ground voltage VSS to generate a divided voltage VDD_REF. The comparator 440B compares the divided voltage VDD_REF with the second reference voltage VREF2. The driver 460B drives the pumping voltage VPP or the external power supply voltage VDDEXT in response to the output voltage of the comparator 440B.

The voltage divider 420B includes a first resistor R2 and a second resistor R3, which are connected in series between the external power supply voltage VDDEXT and the ground voltage VSS. The voltage divider 420B generates the divided voltage VDD_REF at a connection node D_NODE of the first resistor R2 and the second resistor R3.

In addition, the comparator 440B includes a current mirror that operates in response to an enable signal EN.

The current mirror includes an enable controller 442B, a first resistor 444B, a second resistor 446B, and a mirror circuit 448B. The enable controller 442B enables or disables the current mirror in response to the enable signal EN. The first resistor 444B has a predetermined resistance and outputs to a control node CON_NODE a voltage dropped by its own resistance from the divided voltage VDD_REF. The second resistor 446B has a predetermined resistance and outputs to an output node OUT_NODE a voltage dropped by its own resistance from the second reference voltage VREF2. The mirror circuit 448B controls a level of the voltage applied to the output node OUT_NODE in response to the voltage of the control node CON_NODE.

When the divided voltage VDD_REF decreases in the current mirror, the voltage of the control node CON_NODE falls and the voltage of the output node OUT_NODE rises. When the divided voltage VDD_REF increases, the voltage of the control node CON_NODE rises and the voltage of the output node OUT_NODE falls.

The enable controller 442B serves as a current source of the current mirror and includes a first NMOS transistor NMOS1 configured to control the connection of the current mirror and the ground voltage VSS in response to the enable signal EN.

The first resistor 444B includes a second NMOS transistor NMOS2 having a drain connected to the output node OUT_NODE, a source connected to the current source, and a gate receiving the divided voltage VDD_REF.

The second resistor 446B includes a third NMOS transistor NMOS3 having a drain connected to the output node OUT_NODE, a drain connected to the current source, and a gate receiving the second reference voltage VREF2.

The driver 460B includes a first driver 462B, and a second driver 464B, and a third driver 466B. The first driver 462B drives the output voltage of the comparator 440B to logic HIGH or logic LOW. The second driver 464B drives the external power supply voltage VDDEXT in response to the output signal of the first driver 462B. The third driver 466B drives the pumping voltage VPP in response to an inverted output signal of the first driver 462B.

The first drive 462B includes an inverter chain with a plurality of inverters.

The second driver 464B includes a first PMOS transistor PMOS3 having a drain connected to the external power supply voltage VDDEXT, a source connected to a voltage input node VOL_INPUT, and a gate receiving the output signal of the first driver 462B.

The third driver 466B includes an inverter INV3 configured to invert the output signal of the first driver 462B, and a second PMOS transistor PMOS4 having a drain connected to the pumping voltage VPP, a source connected to the voltage input node VOL_INPUT, and a gate receiving the output signal of the inverter INV3.

The internal voltage generator 200B uses the output voltage of the voltage supplying unit 400B, i.e., the pumping voltage VPP or the external power supply voltage VDDEXT, as a supply voltage.

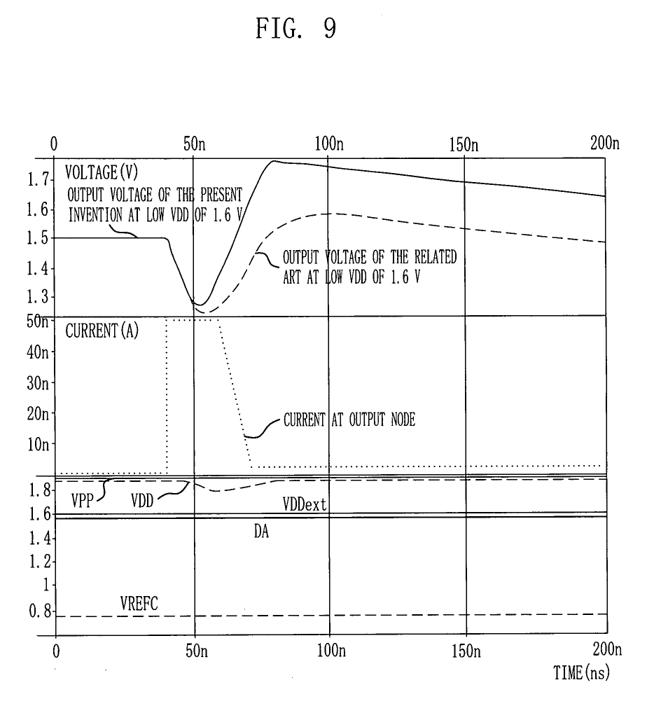

FIG. 9 is a simulation graph showing a level variation of the internal voltages when the internal voltages generated using the low VDD voltage of 1.6 V in the internal voltage generating circuits of FIGS. 1 and 7 are respectively used in the internal circuit.

As shown, a level of the internal voltage IN_VOL in the internal voltage generating circuit of FIG. 7 is changed differently from that in the internal voltage generating circuit of FIG. 1.

The internal voltage generated using the low VDD voltage of 1.6 V, by the internal voltage generating circuit of FIG. 7 and used in the internal circuit 300B, maintains a relatively higher level than the internal voltage generated using the low VDD voltage of 1.6 V by the internal voltage generating circuit of FIG. 1.

Likewise, when the internal voltages are used in the internal circuit 300B, the internal voltage IN_VOL generated by the internal voltage generating circuit of FIG. 7 has a faster recovery speed than the internal voltage IN_VOL generated by the conventional internal voltage generating circuit of FIG. 1.

Therefore, the internal voltage generating circuit of the present invention operates more stably than the conventional internal voltage generating circuit of FIG. 1.

As described above, even when the level of the external power supply voltage becomes lower and thus a low voltage is inputted, the level of the internal voltage used in the internal circuit can be stably maintained. This makes the semiconductor device operate stably.

In the above embodiments of the present invention, types and kinds of the logic gates and the transistors can be changed in accordance with polarity of the signals.

While the present invention has been described with respect to the specific embodiments, it will be apparent to those skilled in the art that various changes and modifications may be made without departing from the spirit and scope of the invention as defined in the following claims.

What is claimed is:

1. An internal voltage generating circuit, comprising:
a voltage supplying unit configured to selectively supply an external power supply voltage or a pumping voltage having a voltage level higher than the external power supply voltage; and
an internal voltage generating unit configured to use the voltage supplied by the voltage supplying unit as a supply voltage.

2. The internal voltage generating circuit as recited in claim 1, wherein the voltage supplying unit receives an activation signal from an external controller, the activation signal being activated in response to an operation of a dynamic random access memory (DRAM), and supplies one of the pumping voltage and the external power supply voltage in response to the activation signal.

3. The internal voltage generating circuit as recited in claim 2, wherein the external controller activates the activation signal in an active operation of the DRAM in which a level of the external power supply voltage is dropping.

4. The internal voltage generating circuit as recited in claim 2, wherein the external controller activates the activation signal in a refresh operation of the DRAM in which a level of the external power supply voltage is dropping.

5. The internal voltage generating circuit as recited in claim 2, wherein the external controller deactivates the activation signal in a precharge operation of the DRAM in which a level of the external power supply voltage is normal.

6. The internal voltage generating circuit as recited in claim 2, wherein the voltage supplying unit supplies the pumping voltage as a supply voltage of the internal voltage generating unit when the activation signal is activated, and supplies the external power supply voltage as the supply voltage of the internal voltage generating unit when the activation signal is deactivated.

7. The internal voltage generating circuit as recited in claim 2, wherein the voltage supplying unit comprises:
a pulse generator configured to generate a pulse toggled for a predetermined time in response to the activation signal; and
a driver configured to drive the pumping voltage or the external power supply voltage in response to the toggling of the pulse.

8. The internal voltage generating circuit as recited in claim 7, wherein the pulse generator comprises:
a delay circuit configured to delay the activation signal by a predetermined time; and
a NAND gate configured to receive the activation signal and an output signal of the delay circuit.

9. The internal voltage generating circuit as recited in claim 8, wherein the delay circuit comprises an inverter chain with a plurality of inverters.

10. The internal voltage generating circuit as recited in claim 8, wherein the driver comprises:
a first driver configured to drive the pulse to logic HIGH or logic LOW in response to the toggling of the pulse;
a second driver configured to drive the external power supply voltage in response to an output signal of the first driver; and
a third driver configured to drive the pumping voltage in response to an inverted output signal of the first driver.

11. The internal voltage generating circuit as recited in claim 10, wherein the first driver comprises a first inverter configured to receive the pulse.

12. The internal voltage generating circuit as recited in claim 10, wherein the second driver comprises a p-type metal oxide semiconductor (PMOS) transistor having a drain connected to the external power supply voltage, a source connected to a voltage input node, and a gate receiving the output signal of the first driver.

13. The internal voltage generating circuit as recited in claim 10, wherein the third driver comprises:
an inverter configured to invert the output signal of the first driver; and
a PMOS transistor having a drain connected to the pumping voltage, a source connected to a voltage input node, and a gate receiving an output signal of the inverter.

14. The internal voltage generating circuit as recited in claim 1, wherein the voltage supplying unit detects a level of the external power supply voltage and supplies one of the pumping voltage and the external power supply voltage in accordance with the detection result.

15. The internal voltage generating circuit as recited in claim 14, wherein the voltage supplying unit supplies the pumping voltage as a supply voltage of the internal voltage generating unit when the external power supply voltage is relatively low, and supplies the external power supply as the supply voltage of the internal voltage generating unit when the external power supply voltage is relatively high.

16. The internal voltage generating circuit as recited in claim 14, wherein the voltage supplying unit comprises:
a voltage divider connected in series between the external power supply voltage and a ground voltage to output a divided voltage;
a comparator configured to compare the divided voltage with a reference voltage; and
a driver configured to drive the pumping voltage or the external power supply voltage in response to an output voltage of the comparator.

17. The internal voltage generating circuit as recited in claim 16, wherein the voltage divider comprises a first resistor and a second resistor connected in series between the external power supply voltage and the ground voltage to output the divided voltage at a connection node of the first resistor and the second resistor.

18. The internal voltage generating circuit as recited in claim 16, wherein the comparator comprises a current mirror configured to operate in response to an enable signal.

19. The internal voltage generating circuit as recited in claim 18, wherein the current mirror comprises:
an enable controller configured to enable or disable the current mirror in response to the enable signal;
a first resistor having a first resistance, configured to output a voltage dropped by the first resistance from the divided voltage at an output node;
a second resistor having a second resistance, configured to output a voltage dropped by the second resistance from the second reference voltage at a control node; and
a mirror circuit configured to adjust a level of a voltage applied to the output node in response to a voltage of the control node.

20. The internal voltage generating circuit as recited in claim 19, wherein the current mirror decreases the voltage of the control node and increases the voltage of the output node when the divided voltage decreases, and increases the voltage of the control node and decreases the voltage of the output node when the divided voltage increases.

21. The internal voltage generating circuit as recited in claim 19, wherein the enable controller comprises a PMOS transistor serving as a current source of the current mirror, the PMOS transistor being configured to control a connection of the current mirror and the ground voltage in response to the enable signal.

22. The internal voltage generating circuit as recited in claim 19, wherein the first resistor comprises a n-type metal oxide semiconductor (NMOS) transistor having a drain connected to the output node, a source connected to the current source, and a gate receiving the divided voltage.

23. The internal voltage generating circuit as recited in claim 19, wherein the second resistor comprises an NMOS transistor having a drain connected to the control node, a source connected to the current source, and a gate receiving the reference voltage.

24. The internal voltage generating circuit as recited in claim 19, wherein the driver comprises:
a first driver configured to drive an output voltage of the comparator to a logic high level or a logic low level;
a second driver configured to drive the external power supply voltage in response to an output signal of the first driver; and
a third driver configured to drive the pumping voltage in response to an inverted output signal of the first driver.

25. The internal voltage generating circuit as recited in claim 24, wherein the first driver comprises an inverter chain with a plurality of inverters.

26. The internal voltage generating circuit as recited in claim 24, wherein the second driver comprises a PMOS transistor having a drain connected to the external power supply voltage, a source connected to a voltage input node, and a gate receiving the output signal of the first driver.

27. The internal voltage generating circuit as recited in claim 24, wherein the third driver comprises:
an inverter configured to invert the output signal of the first driver; and
a PMOS transistor having a drain connected to the pumping voltage, a source connected to a voltage input node, and a gate receiving an output signal of the inverter.

28. An internal voltage generating circuit, comprising:
a reference voltage generating unit configured to receive an external power supply voltage to generate a reference voltage;
a pumping voltage generating unit configured to generate a pumping voltage having a voltage level higher than the external power supply voltage;
a voltage supplying unit configured to receive an activation signal corresponding to a preset operation of a dynamic random access memory (DRAM), to supply the pumping voltage or the external power supply voltage in response to the activation signal;
an internal voltage generating unit configured to generate an internal voltage in response to the reference voltage, the internal voltage generating unit being configured to use the voltage supplied by the voltage supplying unit as a supply voltage; and
an internal circuit configured to receive the internal voltage to perform a preset operation.

29. The internal voltage generating circuit as recited in claim 28, wherein the activation signal is input from an external controller.

30. The internal voltage generating circuit as recited in claim 29, wherein the external controller activates the activation signal in an active operation or a refresh operation of the DRAM in which a level of the external power supply voltage is relatively low, and deactivates the activation signal in a precharge operation of the DRAM in which a level of the external power supply voltage is normal.

31. The internal voltage generating circuit as recited in claim 29, wherein the voltage supplying unit supplies the pumping voltage as a supply voltage of the internal voltage generating unit when the activation signal is activated, and supplies the external power supply voltage as the supply voltage of the internal voltage generating unit when the activation signal is deactivated.

32. The internal voltage generating circuit as recited in claim 31, wherein the voltage supplying unit comprises:
a pulse generator configured to generate a pulse toggled for a predetermined time in response to the activation signal; and
a driver configured to drive the pumping voltage or the external power supply voltage in response to the toggling of the pulse.

33. The internal voltage generating circuit as recited in claim 32, wherein the pulse generator comprises:
a delay unit configured to delay the activation signal by a predetermined time; and
a NAND gate configured to receive the activation signal and an output signal of the delay circuit.

34. The internal voltage generating circuit as recited in claim 32, wherein the driver comprises:
a first driver configured to drive the pulse to logic HIGH or logic LOW in response to the toggling of the pulse;
a second driver configured to drive the external power supply voltage in response to an output signal of the first driver; and
a third driver configured to drive the pumping voltage in response to an inverted output signal of the first driver.

35. A method for generating an internal voltage, comprising:
generating an activation signal in response to a preset operation of a dynamic random access memory (DRAM);
generating a pulse toggled in response to the activation signal;
alternately supplying a pumping voltage and an external power supply voltage in response to the toggling of the pulse; and
receiving the pumping voltage or the external power supply voltage to generate the internal voltage.

36. The method as recited in claim 35, wherein the outputting of the activation signal comprises activating the activation signal in an active operation of the DRAM in which a level of the external power supply voltage has dropped below normal.

37. The method as recited in claim 35, wherein the outputting of the activation signal comprises activating the activation signal in a refresh operation of the DRAM in which a level of the external power supply voltage has dropped below normal.

38. The method as recited in claim 35, wherein the outputting of the activation signal comprises deactivating the activation signal in a precharge operation of the DRAM in which a level of the external power supply voltage is normal.

39. The method as recited in claim 35, wherein the pumping voltage is supplied when the activation signal is activated, and the external power supply voltage is supplied when the activation signal is deactivated.

40. An internal voltage generating circuit, comprising:
a reference voltage generating unit configured to receive an external power supply voltage to generate a first reference voltage and a second reference voltage;
a pumping voltage generating unit configured to generate a pumping voltage having a voltage level higher than the external power supply voltage;
a voltage supplying unit configured to detect a level of the external power supply voltage in response to the first reference voltage and supply the pumping voltage or the external power supply voltage, selected in accordance with the detection result;
an internal voltage generating unit configured to generate the internal voltage in response to the second reference voltage and use the voltage supplied from the voltage supplying unit as a supply voltage; and
an internal circuit configured to receive the internal voltage to perform a preset operation.

41. The internal voltage generating circuit as recited in claim 40, wherein the voltage supplying unit supplies the pumping voltage as the supply voltage of the internal voltage generating unit when the level of the external power supply voltage is relatively low, and supplies the external power supply voltage as the supply voltage of the internal voltage generating unit when the level of the external power supply voltage is relatively high.

42. The internal voltage generating circuit as recited in claim 41, wherein the voltage generating unit comprises:
a voltage divider connected in series between the external power supply voltage and a ground voltage to generate a divided voltage;
a comparator configured to compare the divided voltage with the reference voltage; and
a driver configured to drive the pumping voltage or the external power supply voltage in response to an output voltage of the comparator.

43. The internal voltage generating circuit as recited in claim 42, wherein the comparator comprises a current mirror configured to operate in response to an enable signal.
